(19) United States
(12) Patent Application Publication
(10) Pub. No.: US 2008/0131350 A1
(43) Pub. Date: Jun. 5, 2008

(54) Method for Production of Metal Nitride and Oxide Powders Using an Auto-Ignition Combustion Synthesis Reaction

(76) Inventors: Douglas E. Burkes, Idaho Falls, ID (US); John J. Moore, Evergreen, CO (US); Marissa M. Reigel, Vail, CO (US); John Rory Kennedy, Idaho Falls, ID (US)

Correspondence Address: GREENLEE WINNER AND SULLIVAN P C, 4875 PEARL EAST CIRCLE, SUITE 200, BOULDER, CO, 80301, US

(21) Appl. No.: 11/848,410

(22) Filed: Aug. 31, 2007

Related U.S. Application Data
(60) Provisional application No. 60/824,178, filed on Aug. 31, 2006.

(51) Int. Cl. C01B 21/06

(52) U.S. Cl. 423/409; 423/605

(57) ABSTRACT

A method of preparing a high purity metal nitride and/or oxide powder is provided, comprising: heating a metal salt and an organic fuel to an ignition temperature in a nitrogen-rich atmosphere, forming a first composition; and optionally heating the first composition to a heat treatment temperature, which heat treatment temperature is above the ignition temperature and below 1000° C., in a nitrogen-rich atmosphere until the metal nitride and/or oxide powder is formed.

### CROSS-REFERENCE TO RELATED APPLICATIONS

This application takes priority from U.S. provisional application 60/824,178, filed Aug. 31, 2006, which is hereby incorporated by reference herein.

### STATEMENT REGARDING FEDERALLY SPONSORED RESEARCH OR DEVELOPMENT

This invention was made with U.S. government support under Cooperative Agreement NCC8-238 awarded by NASA and the Center for Commercial Applications of Combustion in Space. This invention was made with U.S. government support under grant number DE-FC07-051D14648 and DE-AC07-051D14517 awarded by the Department of Energy. The U.S. government has certain rights in the invention.

### BACKGROUND OF THE INVENTION

High purity metal nitride or oxide powders are desirable for industrial and research use. Metal nitrides have material, thermal, optical, electronic and magnetic properties that make these compounds useful in industry and research applications. Metal oxide powders are important for use in ceramics manufacturing.

Manufacturing techniques currently in use for metal nitride or oxide powders are expensive, and time and energy consuming. Yun et al. (U.S. Pat. No. 6,319,421) discloses production of a ceramic oxide powder with a grain size of 5 μm or less by dissolving constituent ceramic elements in a solvent or dispersion medium, adding citric acid and employing a thermal treatment at a temperature of 100 to 500° C. Martirosyan et al., (US published application 2006/0097419) discloses synthesis of ceramic oxides by reaction of carbon powder, metal-containing oxide compounds and oxygen by ignition. James et al. (U.S. Pat. No. 6,761,866) discloses methods to synthesize single component metal oxide powders by dissolving a salt of the metal in an organic solvent or water, and complexing the metal with a complexing agent (such as citric acid, EDTA or oxalic acid), adding nitric acid and ammonia and heating. Holt (U.S. Pat. No. 4,446,242) discloses synthesis of metal nitrides by igniting a mixture of a metal azide and a transition metal of the IIIB, IVB groups or a rare earth metal. Pederson et al., (U.S. Pat. No. 5,114,702) discloses production of metal oxide powder by evaporating a homogeneous aqueous mixture of a metal salt and an amino acid and then igniting. Qiu reports synthesis of aluminum, chromium or iron nitrides from metal-urea complexes by heating a precipitate formed by evaporation of ethanol from a metal salt-urea solution. The heating was performed at 300-1000° C. for 1-15 hours under an ammonia or nitrogen gas atmosphere (Qiu and Gao, “Metal-Urea complex—A precursor to metal nitrides” J. Am. Ceram. Soc., 87(3) 352-57 (2004)).

Americium nitride is a transuranic compound obtained from spent nuclear fuel. This compound is recycled in new generation fuels for high burn-up applications. Americium, uranium, plutonium and neptunium nitride and/or mixed oxide powders are currently fabricated using carbothermic reduction, where the metal oxide feedstock is heated to high temperatures ranging from 1300 C to 1750 C for extended durations ranging from one to four hours in the presence of excess carbon black under nitrogen and nitrogen-4% hydrogen gas mixtures (Suzuki, Arai, Okamoto, and Ohmichi, J. Nucl. Sci. Technol. 31 (1994) 677; Minato, Akabori, Takano, Arai, Nakajima, Itoh and Ogawa, J. Nucl. Mater. 320 (2003) 18). The carbothermic reduction process is costly and requires complex production equipment. In addition, significant amounts of residual carbon and metal oxide may remain as impurities, defined as an undesirable compound, in the final nitride product. These impurities can contribute to a low degree of conversion and loss of desired stoichiometry. Increased temperatures may remove the remaining carbon impurity and unconverted metal oxide, but could result in volatilization of the metal component since nitrides do not exhibit congruent melting, rather dissociation of nitrogen gas from the molten metal. Increased reaction times may also contribute to carbon and/or oxygen impurity removal, but can significantly increase process cost, time, equipment maintenance and safety considerations. When a carbon containing nitride, even as low as parts per million (ppm) carbon impurity, is mixed with zirconium, such as would be performed to produce ceramic bearing nitride fuels for transmutation, a zirconium carbide compound will form that can lead to difficulty in fuel reprocessing, as is the advantage of nuclear transmutation fuels. An additional fabrication technique for nuclear nitrides is the hydride-dehydride process (Oetting and Leitnaker, J. Chem. Thermodynamics 4 (1972) 199-211). Employing this method, pure metals (uranium, plutonium, neptunium, americium, etc.) are introduced as the feedstock into a furnace at approximately 400° C. and exposed to pure hydrogen (hydrided). The hydrided powder is then subjected to a vacuum at the same temperature to dissociate and remove hydrogen (dehydriding). The dehydrided powder is then subjected to a series of heating steps (up to 2100° C.) under pure nitrogen on the order of one hour. The disadvantage of this technique is that a pure metal feedstock is required and the safety requirements of working with pyrophoric metals and pure hydrogen are significantly increased.

Therefore, in order for nitrides to be a feasible transmutation nuclear fuel, such as americium nitride (AmN), plutonium nitride (PuN), neptunium nitride (NpN), curium nitride (CmN) and uranium nitride (UN), an improvement in the fabrication process for metal nitride and/or oxide powders is needed. This technology may also be extended for industrial and commercial production of more “common” nitrides, such as those described herein. Manganese and praseodymium can be considered as surrogate materials for americium, based on the material melt temperature, heat of formation value and vapor pressure. As such, production methods for manganese and praseodymium nitride and/or oxide powders can be used to prepare AmN and/or oxide powders as well as other nuclear fuels such as PuN, NpN and UN.

### SUMMARY OF THE INVENTION

This invention provides a method for making high purity metal nitride and/or metal oxide powders using an Auto-ignition Combustion Synthesis (AICS) reaction of a metal salt reactant and a fuel. More specifically, provided is a method of preparing a high purity metal nitride and/or oxide powder, comprising:

heating a metal salt and an organic fuel to an ignition temperature in a nitrogen-rich atmosphere, forming a first composition; optionally quenching the first composition; and optionally heating the resultant product to a heat treatment temperature in an appropriate atmosphere resulting in a fine, crystalline metal nitride and/or oxide powder. The appropriate atmosphere for heat treatment and all other steps is well known to one of ordinary skill in the art without undue experimentation using the description provided herein.

The process disclosed herein quenches the product using a high-purity gas with high specific heat capacity, e.g. helium or liquid nitrogen, in a vacuum, or by allowing the product to cool, either under natural convection or by other means. If desired, a subsequent heat treatment is used to obtain a high degree of conversion of the desired product. In one embodiment, the heat treatment step is performed for a time greater than one minute and less than one hour. In one embodiment, the heat treatment temperature is above the ignition temperature and 1000° C. or below. In one embodiment, the reaction is complete after ignition followed by quenching by cooling of the resultant product(s) either naturally or by some forced means, for example using a flow of gas or vacuum. If heat treatment is necessary or desired, the heat treatment time and/or heat treatment temperature is dependent upon the desired product system (i.e. Mn, Zr, Al, Pr, Am, etc.) and the desired phase or mixture of phases (i.e. pure nitride, nitride/oxide mixture, pure oxide, etc.), as described further herein and known in the art without undue experimentation. If heat treatment is used, and the optimum heat treatment duration and/or temperature are not met, loss of product stoichiometry can occur, residual carbon in the product may be present, and full conversion of the desired product(s) may not be reached.

Metals that can be used in the metal salts include aluminum, americium, calcium, cerium, chromium, dysprosium, hafnium, iron, lanthanum, magnesium, manganese, neptunium, plutonium, praseodymium, uranium, zirconium and mixtures thereof.

One class of products that can be prepared using the methods of the invention is americium nitride, neptunium nitride, plutonium nitride and uranium nitride. Manganese nitride forms a class of products that can be prepared using the methods of the invention. One class of products that can be prepared using the methods of the invention are high purity metal nitride powders.

Unless otherwise specified, the metal salt reactant can contain any anion, complexing agent or mixture thereof that allows the metal salt reactant to perform its function in the methods described herein. Some examples of anions are nitrate, chloride, and acetate. However, nitrates are particularly useful since most metal nitrates are readily available or easily produced from oxides, are inexpensive compared to pure metal feedstock materials, are very stable, and are very soluble in water.

Examples of low-cost, readily available, easy to work with organic fuels include urea (CO(NH₂)₂), glycine (C₂H₅NO₂), N-methylurea (CH₃NHCONH₂), citric acid (HOC(COOH)(CH₂COOH)₂), stearic acid (CH₃(CH₂)₁₆COOH), ammonium bicarbonate (NH₄HCO₃), ammonium carbonate ((NH₄)₂CO₃) and combinations thereof. Other organic fuels can be used. The reaction can also be carried out in the presence of nitrogen containing gasifying additives to improve conversion efficiency and speed of reaction. Examples of gasifying additives are sodium azide (NaN₃) and lithium nitride (Li₃N). Other gasifying additives can be used, as known in the art without undue experimentation. Combinations of both metal salt reactants and organic fuels with gasifying additives, if used, along with the temperature profiles can be used to tailor the reducing/oxidation power of the mixture and control off-gas concentrations (i.e. carbon, nitrogen, hydrogen, oxygen) that ultimately result in control of reaction temperature and time as well as product stoichiometry and particle morphology. There may be multiple stages in each step where, for example, the reactants are held at different temperatures for different times.

Combustion synthesis methods are generally described in Patil, Current Opinion in Solid State and Materials Science 6 (2002) 507-512.

As used herein, “nitrogen-rich atmosphere” means the nitrogen content of the gas in a space contains a greater percentage of nitrogen than air. Examples of nitrogen-rich atmospheres include using nitrogen gas, ammonia gas and other nitrogen-containing gases in combination with, or in place of, air in the reactor. The nitrogen-rich environment may also contain hydrogen, carbon, hydrocarbons, and other substances as long as there is a greater percentage of nitrogen than air. If desired, additional sources of nitrogen, such as sodium azide (NaN₃), lithium nitride (Li₃N) and/or ammonium nitrate (NH₄NO₃), can be added to the starting mixture of metal salt and organic fuel to form the desired product. If additional sources of nitrogen are added, the product is more likely to form nitride products, depending on other factors such as initial reactant stoichiometry, and other factors known in the art. However, in the case of sodium azide and/or lithium nitride, the powder must be post-processed to remove remaining sodium and/or lithium decomposition product(s) that are not vaporized and removed from the reactor during processing, if pure powder is desired. The high purity powders produced by the methods described herein may consist solely of metal nitride and/or oxide components. For the formation of pure or mixed oxide powders, the atmosphere does not necessarily need to be nitrogen-rich, but could be inert or contain more air than nitrogen.

Powders ranging in size from micrometers to nanometers can be produced by varying starting reactant stoichiometry and reactant to fuel mixture ratio, thereby controlling the maximum temperature observed during the AICS reaction. Generally, lower temperatures prevent the product particles from sintering. Lower temperatures are achieved by lower than or significantly higher than stoichiometric fuel contents in the mixture, lower ambient temperatures resulting in prolonged duration of decomposition of the starting reactants, along with slower heating rates or addition of diluents that serve as a heat sink absorbing energy from the reaction system. However, higher fuel contents may be required to increase the amount of carbon initially present in the mixture thereby removing oxygen and producing nitrides. Lower fuel contents will decrease the amount of carbon initially present in the mixture and may produce oxides. These changes can be made by one of ordinary skill in the art using the description provided herein and the knowledge in the art without undue experimentation. Conversely, higher temperatures promote particle sintering but can result in a loss of sub-micron features and produce a less crystalline phase of the product powder. Higher temperatures are achieved by fuel contents closer to the stoichiometric value of the mixture, higher ambient temperatures and heating rates that increase the rate of reactant decomposition and pre-heat, as well as ensuring full conversion of the reactants to the desired products by careful selection of starting mixture stoichiometry. These are extremely important processing parameters and are often overlooked by similar fabrication processes.

Auto-ignition Combustion Synthesis (AICS) overcomes the limitations and deficiencies of other fabrication processes. The AICS method takes advantage of an exothermic, i.e. heat generating, chemical reaction that is rapid and self-sustaining, meaning that the heat generated by the exothermic chemical reaction is sufficient to drive the reaction itself so that an external heat source is not required for sustaining the chemical reaction. The invention disclosed herein takes advantage of redox (reduction-oxidation) mixtures of water soluble metal salts with a suitable organic fuel. In short, the AICS fabrication process brings a mixture of the desired reactant salt(s) and organic fuel to a boil until the mixture ignites spontaneously followed by a swift and self-sustaining combustion reaction in a near simultaneous fashion. If desired, the combustion reaction can be followed by a heat treatment step that results in a powder having the desired composition. Although applicant does not wish to be bound by theory, it is believed that during initial heating, structural water contained within the reactant salt (such as nitrates) is released and decomposition of the organic fuel forms water resulting in a semi-saturated solution. Nitric or hydrochloric acid may be added to the mixture to aid in dissolving the metal salt(s) and organic fuel(s).

As used herein, “organic” means carbon-containing. In one particular embodiment, the organic fuel contains elements other than carbon, and is not solely a carbon-containing material. Examples of materials which are solely carbon-containing include carbon black, graphite, activated carbon, soot or petroleum coke.

In the invention described herein, the reaction mixture is self-ignited and propagated when heated.

After the powders are prepared using the methods described herein, the powder can be formed into a desired shape using methods known in the art without undue experimentation.

As used herein, “high purity” materials are materials which contain less than or equal to 5% of elements that are not part of the desired product. In one embodiment, “high purity” materials are materials which contain less than or equal to 0.1% of elements that are not part of the desired product. In one embodiment, “high purity” materials are materials which contain less than or equal to 0.5% of elements that are not part of the desired product. These impurities are typically carbon or carbon-containing species (outside of any desired carbon-containing species) and/or any undesired oxide species. For pure oxides or pure nitrides, purities of greater than 95%, 99.5% and 99.9% are particularly useful. In one embodiment, mixtures of oxides and nitrides should be at least 95% pure.

The metal nitride and/or oxide powders formed using the methods described herein may be high purity metal nitride powders, metal nitride powders with up to 50% metal oxide constituents, high purity metal oxide powders, or metal oxide powders with up to 50% metal nitride constituents. The metal oxides formed may have any oxidation state of the metal, or mixtures thereof (herein referred to as “mixed oxides”). One example of mixed oxides is a product which includes MnO and Mn₂O₃.

As used herein, “ignition temperature” means a temperature where the reaction mixture spontaneously ignites. This temperature is typically the lowest temperature at which one of the reactants decomposes. The reaction mixture may be maintained at the ignition temperature for some time before ignition occurs. Suitable ignition temperatures depend on the composition of the reactants, and are easily determined by one of ordinary skill in the art without undue experimentation.

As used herein, “heat treatment temperature” means a temperature above the reaction temperature where reaction of the formed product species and/or impurities remaining from the initial chemical reaction continue to or have the potential to continue reacting with the gaseous environment. Generally, the sole purpose of the heat treatment step is to promote complete conversion of the desired product species, for example, by reaction with anhydrous ammonia or methane. Typically, carbon and/or carbon containing species are removed during the heat treatment step. Ultimately, a higher or lower heat treatment temperature can control conversion of the final product and/or loss of desired product stoichiometry along with lower or higher, respectively, impurity contents. These modifications can be made by one of ordinary skill in the art using the description provided here, as well as the knowledge of one of ordinary skill in the art without undue experimentation.

As used herein, “powder” means a material in a solid form able to be readily used or able to be readily pressed into a desired shape. Powder is understood to be different than pieces or bulk structures of product. Powder can be further milled to a desired size, if need be, but is not necessarily required in the sense of the word used herein. Powder offers advantages over other material forms (i.e. pieces, structures, etc.) in the fact that powders are able to adapt to a specific profile or shape.

The reaction described herein can be used to prepare various particle sizes, such as micrometer to nanometer particle diameters. In one embodiment, the product has an average particle size between about 1 nm to about 800 micron, and all intermediate values and ranges therein. In one embodiment, the average particle diameter produced is less than about 500 nm. In one embodiment, particle diameters are between 500 nm to 900 nm. In one embodiment, particles that are “free-flowing” and have minimal agglomeration of fine particles are formed. In one embodiment, particles around 45 microns are formed. In one embodiment, particles between 100-200 microns are formed. In one embodiment, spherical, uniform, and homogeneous are formed.

In one embodiment, the average particle diameter produced is less than about 1 micron. These various particle sizes can be tailored by varying the starting reactant stoichiometry and reactant-to-fuel mixture ratio, which control the maximum temperature in the reaction. In one embodiment, the particles formed are uniformly sized, i.e., having about 90% of the particles having diameter within 5% of each other.

### BRIEF DESCRIPTION OF THE DRAWINGS

FIG. 1 shows the sequence of events for an exemplary AICS reaction. The first step is initial boiling of the metal salt, fuel, additive mixture shown in (a) at ˜200° C. and 2 min. The second step is significant boiling and off-gassing of water vapour shown in (b) at ˜400° C. and 4 min. The third step is foaming of gel-like mixture and continued off-gassing of carbon-containing and nitrogen containing gaseous species shown in (c) at ˜440° C. and 5 min. Finally, the last step is ignition of the reactant mixture shown in (d.) at ˜450° C. and 5.5 min

FIG. 2 shows X-ray diffraction patterns of powder produced using the AICS process described herein. The bottom pattern was conducted under static anhydrous ammonia gas while the top pattern was conducted under flowing anhydrous ammonia gas. In the patterns, N represents the expected manganese nitride phase, Mn₃N₂, O represents manganese monoxide, MnO and IIO represents manganese II oxide, Mn₂O₃.

FIG. 3 shows a scanning electron photomicrograph of manganese nitride (Mn₃N₂) powder produced using the AICS process described herein. Observation of this photomicrograph reveals small, nano-sized nitride particles that are slightly agglomerated.

FIG. 4 shows X-ray diffraction patterns of the AICS powder product as a function of fuel used. The Figure illustrates the results summarized in Table 1.

FIG. 5 shows a X-ray diffraction pattern illustrating the effect of a gasifying additive, sodium azide, on conversion of the salt to a nitride product.

FIGS. 6 through 9 show photographs of embodiments of some experimental apparatus modifications. In order to minimize oxygen contamination within the Al₂O₃ reaction tube, a new method of tightly securing a flange to the ends of the ceramic tube while still allowing easy access for sample loading and unloading is provided. This is done by securing a modified vacuum clamp around the Al₂O₃ tube with a rubber gasket to protect the ceramic tube from the vacuum clamp, as shown in FIG. 6. The vacuum clamp has three ‘studs’ extending outwards that are used to secure the end flanges to the ceramic tube using wing nuts. The secured flanges are shown in FIGS. 7 (gas inlet side) and 8 (gas outlet side). A photograph of the flange used to seal the Al₂O₃ tube is shown in FIG. 9. Stainless steel flanges may also be used in place of polymer. The use of stainless steel flanges allows the apparatus to sustain higher temperatures for longer durations, extending the lifetime of the flange and minimizing oxygen contamination. As known in the art, various alternative components can be used, providing the components have the same function as the described component.

### DETAILED DESCRIPTION OF THE INVENTION

The examples described herein are intended to be exemplary and not limiting. The examples are intended to aid in understanding the invention.

As is known in the art, it is understood that the same crystal structures and compositions can be named differently and can be represented differently in a formula by those of ordinary skill in the art. Therefore, when a composition is named or a formula shown in the disclosure herein, all equivalent names or formulas are intended to be included.

There are no known previous attempts to facilitate the production of manganese nitride and/or mixed oxide powders employing AICS, and therefore no known attempts to produce americium nitride and/or americium oxide. The exemplary examples provided herein illustrate formation of manganese nitride and/or oxide powders employing only metal nitrate or chloride salts (hydrated or anhydrous) and a suitable organic fuel (urea, methylurea or glycine), employing a furnace capable of reaching a temperature of no more than 1000° C. with a controllable atmosphere and a nitrogen-rich atmosphere, for example nitrogen and/or anhydrous ammonia gas. These examples are easily extended to other materials, using the methods described herein and those methods known to one of ordinary skill in the art without undue experimentation. All of the starting materials and equipment involved in the process are easily attainable at a relatively low cost when compared to other known processing methods. The methods provided here allow fabrication of the high purity metal nitride and/or oxide powders in a quick, proficient and inexpensive manner with little to no safety equipment or manned control.

In the methods described herein, the metal salt is mixed with the appropriate amount and type of organic fuel depending on desired product stoichiometry, i.e. nitride and/or oxide, in a suitable combustible container, such as an Al₂O₃ boat or crucible, in open air. The mixture is then inserted into a furnace with the desired atmosphere (for example, nitrogen or ammonia) and heated from ambient temperature to the ignition temperature of the mixture, for example, between approximately 300 and 500° C. at a suitable heating rate, for example 100° C.·min⁻¹, followed by continuous heating, if necessary or desired, at a prescribed heating rate, not less than 5° C.·min⁻¹ and no more than 100° C.·min⁻¹ to the prescribed reaction temperature, not exceeding 1000° C., or cooling through either natural means or by force, for example vacuum, helium or liquid nitrogen. The Auto-ignition of the mixture typically occurs between 325° C. and 400° C., depending on the composition of the mixture and other process parameters, as known in the art, but is necessarily independent of heating rate so long as the selected heating rate is sufficient to decompose both the organic fuel and metal salt. The purpose of an additional, short heat treatment step is to ensure that any oxygen present in the gaseous environment is removed, for example by reaction with anhydrous ammonia for the case of producing nitrides, if necessary. Carbon and/or carbon containing species can also be removed during the heat treatment step. Ultimately, a higher or lower heat treatment temperature can control conversion of the final product and/or loss of desired product stoichiometry along with lower or higher, respectively, impurity contents. If the secondary heating rate, temperature or duration is too high, decomposition and/or volatilization of the product species may occur. Conversely, if secondary heating rate, temperature or duration is too low, undesired impurities may remain in the final product. These parameters are particular to a given reaction system, desired product, with a defined level of impurity, as known in the art. The minimum heating rate used for either the primary (ignition) or secondary (removal of impurity species) should not be below 5° C.·min⁻¹, while the maximum heating rate used for either step could be as high as or higher than 100° C.·min⁻¹, depending upon safety considerations and equipment limitations. Combustion of the mixture is in the form of a green, orange or red flame, depending on the fuel used and type of product formed, typically lasts less than one minute and is accompanied by a significant amount of gas generation. In one embodiment, the initial reaction of the AICS process lasts less than 10 minutes from insertion into the furnace to extinction of the combustion wave followed by the high temperature heat treatment phase, if needed, which can be an hour or less, thereby equating to a great deal of energy and time savings.

### Apparatus

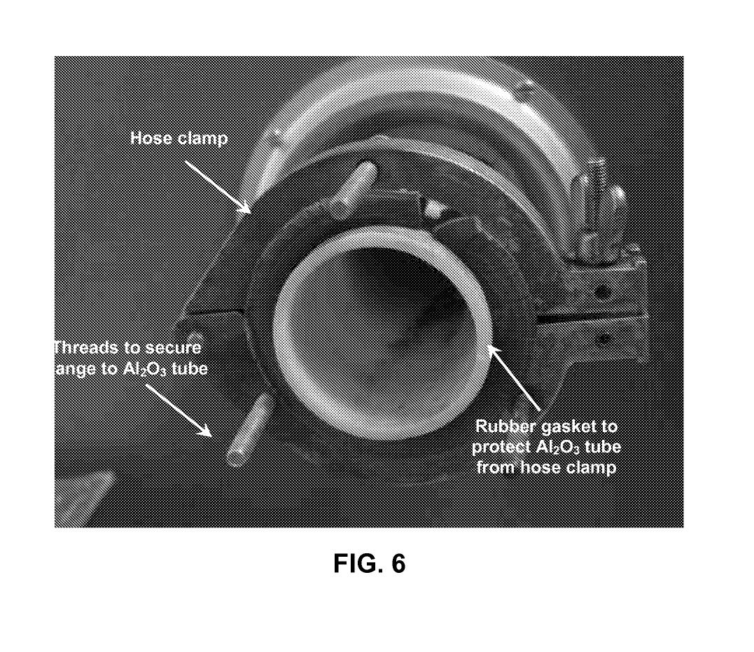

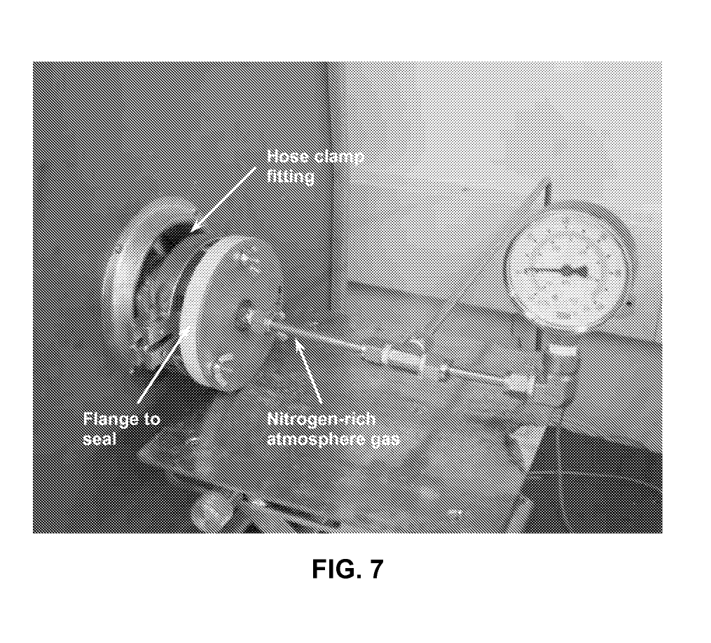

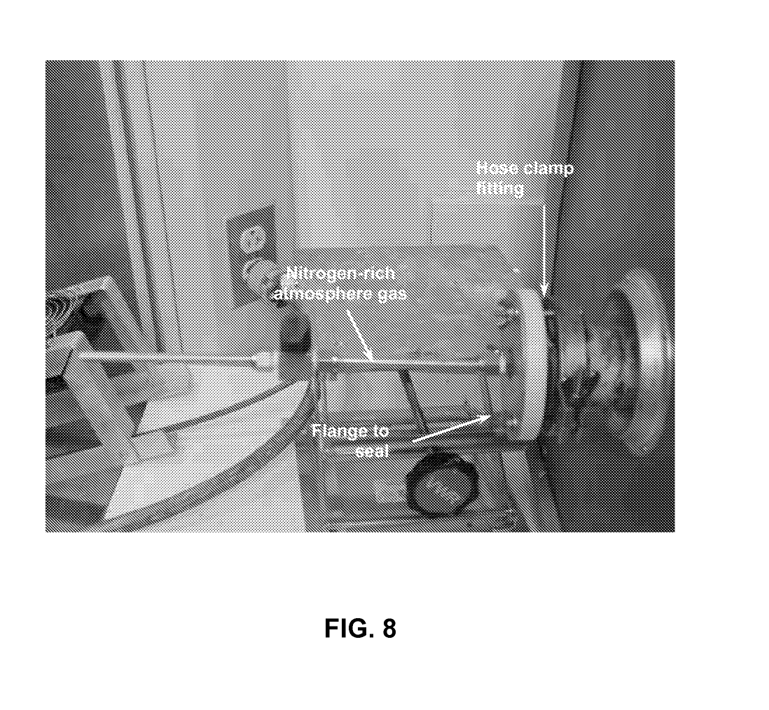

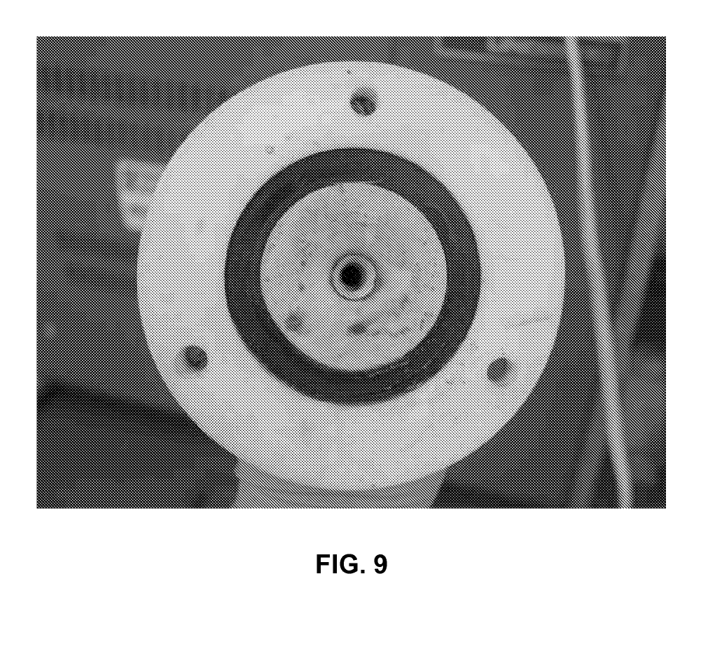

A new method was been developed to seal off an Al₂O₃ ceramic tube inserted into a tube furnace to carry out the experiments described here. Photographs of the experimental set-up are shown in FIGS. 6 through 9. This was done by securing a modified vacuum clamp around the Al₂O₃ tube with a rubber gasket to protect the ceramic tube from the vacuum clamp, as shown in FIG. 6. The vacuum clamp had three ‘studs’ extending outwards that was used to secure the end flanges to the ceramic tube using wing nuts. The secured flanges are shown in FIGS. 7 (gas inlet side) and 8 (gas outlet side). A photograph of the flange used to seal the Al₂O₃ tube is provided in FIG. 9. Quartz or fused silica tubes can also be used in place of Al₂O₃, depending on reaction conditions and cost considerations. As described above, stainless steel flanges may also be used, and other alternative materials may be used, as known in the art without undue experimentation using the description provided here.

### Experimental

Studies have been carried out using hydrated manganese nitrate metal salt (Mn(NO₃)₂.4H₂O) and urea (CO(NH₂)₂) fuel which forms Mn₃N₂ nitride according to the chemical equation below:

$$3 {Mn ( {NO}_{3} )}_{2} \cdot 4 {H}_{2} O + x {CO ( {NH}_{2} )}_{2} + ( 9 - 1.5 x ) {O}_{2} ( g ) \to {Mn}_{3} {N}_{2} + ( 12 + 2 x ) {H}_{2} O ( g ) + {x CO}_{2} ( g ) + ( 3 + x ) {N}_{2} ( g )$$

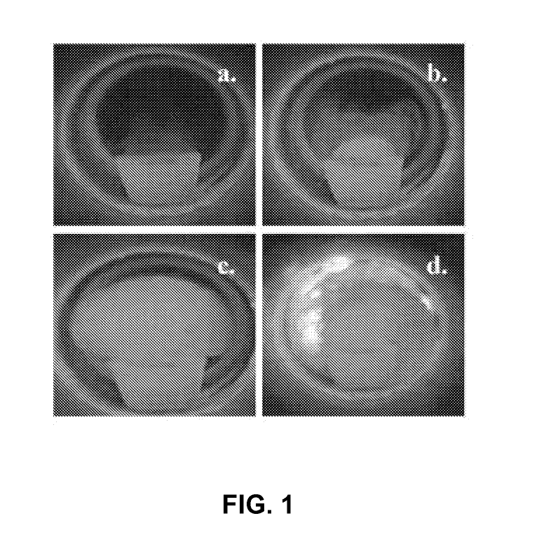

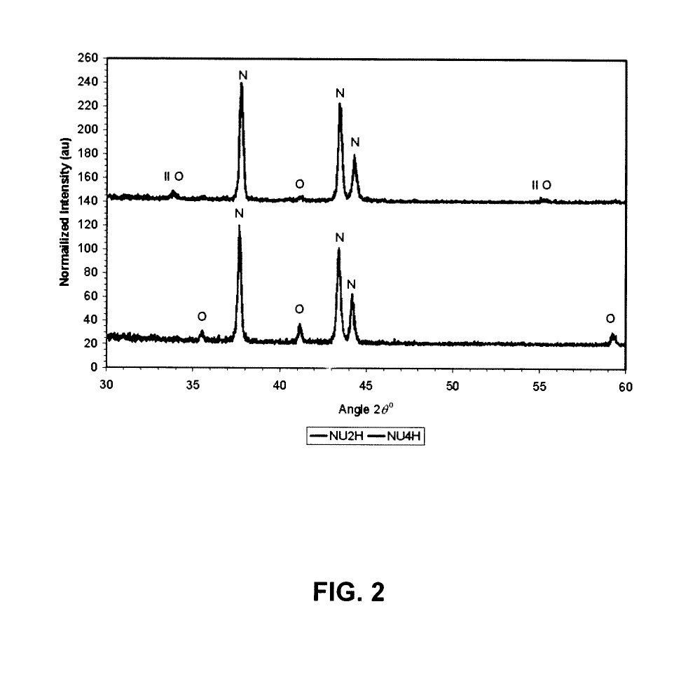

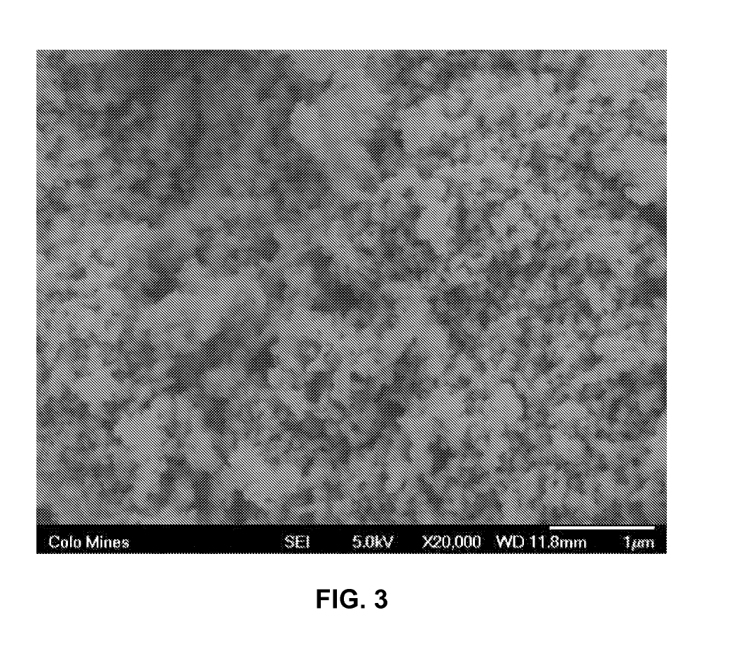

In the equation above, (g) denotes a gaseous state while all other physical forms are solid. Oxygen is included on the right-hand side of the chemical equation to balance the elements, i.e. oxygen that may or may not be available on the reactants side or contained in the gaseous environment will be consumed by the products on the left-hand side of the chemical equation. An initial fuel to salt ratio of 9 was used for this study (x=9). The procedure outlined above was followed with initial heating to 500° C. at 100° C.·min⁻¹ followed by heating to 1000° C. at 10° C.·min⁻¹ under two conditions: (1) a static anhydrous ammonia (NH₃ (g)) condition and (2) a flowing NH₃ (g) condition. An example of typical AICS reaction under a flowing gaseous condition is provided in FIG. 1. X-ray diffraction was carried out on the product powders to verify the presence of Mn₃N₂ and the absence of any metal oxide phases. Resultant X-ray diffraction patterns are shown in FIG. 2. A second reaction was run under the similar conditions with x=25, heating to 800° C. at 100° C.·min⁻¹ followed by holding at 800° C. for 24 minutes. Scanning electron microscopy was carried out on a sample from this experiment and the resultant powder is provided in FIG. 3.

The X-ray diffraction patterns in FIG. 2 show that the method disclosed herein produces high purity metal nitride powders using inexpensive and readily available starting materials and processing equipment with minimal energy in a short time period. In both cases illustrated in FIG. 2, oxides present are minor phases, within the detectable limit of XRD. Depending on the process conditions, including starting reactants, and heating profiles, the products formed can be adjusted. In addition, the scanning electron micrograph in FIG. 3 shows that the powder particles produced from the AICS are nano-sized (sub-micron) and only slightly agglomerated.

Any desired fuel to salt ratio may be used. Some examples are provided here. All intermediate ranges and values of the ratios provided are intended to be included to the extent as if they were specifically listed. Typically, fuel to salt ratios of less than 5:1 promotes oxide formation. The reactor environment does not significantly impact conversion of the reactant salts to oxide forms. In addition, additives are not required to reach full conversion of the salt to oxide form. A furnace temperature of 600° C. to carry out the AICS reaction with no additional heat treatment produces a crystalline powder and a high degree of conversion. Increased furnace temperatures and or the use of subsequent heat treatment steps do not necessarily affect conversion to oxide, but may have an effect on the oxide phase formed, e.g. oxide II, oxide III or oxide IV, and may help remove potential impurities.

Typically, fuel to salt ratios of greater than 9:1 promotes nitride formation. The reactor environment should contain either an inert or nitrogen-rich atmosphere, with a nitrogen-rich atmosphere being currently desired, e.g. ammonia gas. The nitrogen-rich atmosphere has an effect on the nitride product obtained. For example, use of ammonia gas decreases the amount of oxygen impurity present in the final product, but effectively has lower nitrogen content, meaning lower order nitrides are formed. Conversely, use of nitrogen gas produces a product with higher nitrogen content, meaning higher order or more stable nitrides are formed, but the oxygen impurity content is significantly higher. Addition of nitrogen-containing additives, such as sodium azide or ammonium nitrate, increase the conversion efficiency to nitride and decrease the ultimate reaction temperature, or maximum temperature at which the reaction occurs, without a subsequent heat treatment step, typically no more than 600° C. However, use of additives does not necessarily decrease the impurity content in the resultant product. Finally, fuels that contain more nitrogen, i.e. nitromethane compared to urea, typically increase conversion efficiency from the salt to nitride.

Typically, fuel to salt ratios that fall in between the two above cases will produce a mixed oxide/nitride product. In addition, a subsequent heat treatment step is often required to produce mixed products, i.e. the initial reaction product needs to be held at temperature for an extended duration to achieve desired product mixture and particle size. Temperature and duration control the ratio of nitride to oxide and particle size. Higher temperatures and/or extended durations result in more oxide than nitride and coarser particles, while the opposite is true for lower temperatures and/or short durations.

Examples of powder products formed using different fuels are provided in Table 1. Also included in the table is the carbon content of each fuel that ultimately affects impurity content in the final product.

| | | | | Stoichiometric |
|---|---|---|---|---|
| Fuel | Formula | wt % C | Product | ratio |
| nitromethane | CH₃NO₂ | 0.140 | Mostly Mn₃N₂ | 1:10 |
| urea | CO(NH₂)₂ | 1.39 | Mostly MnO | 1:5 |
| methylurea | C₂H₆N₂O | 1.34 | Mixture of MnO & | 1:2.5 |
| | | | Mn₃N₂ | |
| hexamethyl | C₂H₅NO₂ | 14.4 | Mostly Mn₃N₂ | 1:0.81 |
| stearic acid | C₁₈H₃₆O₂ | 4.55 | Mixture of MnO & | 1:0.3 |
| | | | Mn₃N₂ | |

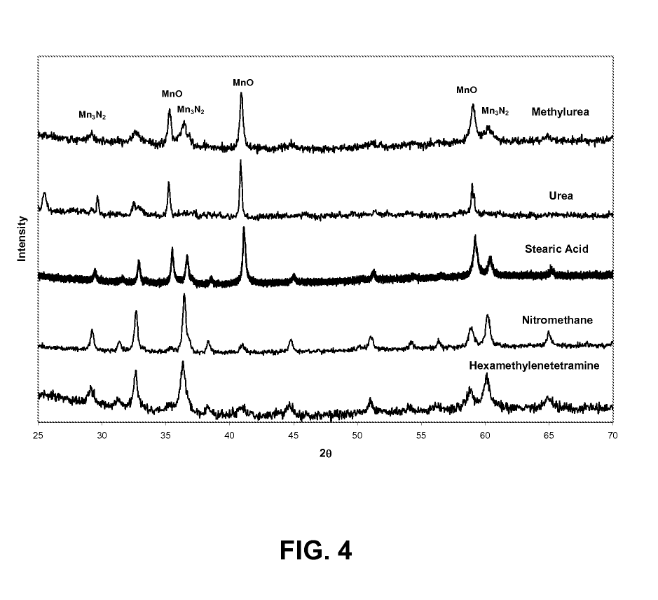

The effect of fuel composition is illustrated in FIG. 4. For this experiment, five different fuels were used in a stoichiometric ratio with the salt, as explained above. The reactants were allowed to ignite between 300-500 C under flowing ammonia gas in the reactor. The resultant product was then quenched by cooling the reactor under a flowing ammonia gas environment immediately after ignition occurred. Observation of FIG. 4 shows that the fuels such as hexamethyl (high carbon, no oxygen) and nitromethane (low carbon, low oxygen) produce a mostly Mn₃N₂ product (brown or dark grey in color) and had ignition temperatures around 330 C. Fuels such as methylurea (low carbon, low oxygen) and stearic acid (high carbon, low oxygen) produce a mixture of MnO and Mn₃N₂. Urea fuel tends to produce a mostly MnO product (green in color) without the subsequent heat treatment step. The fuels that produced oxide or a mix of oxide and nitride had slightly higher ignition temperatures around 350 C. Other fuels, glycine, and citric acid were also tested, but produced non-crystalline (amorphous) products under the conditions used.

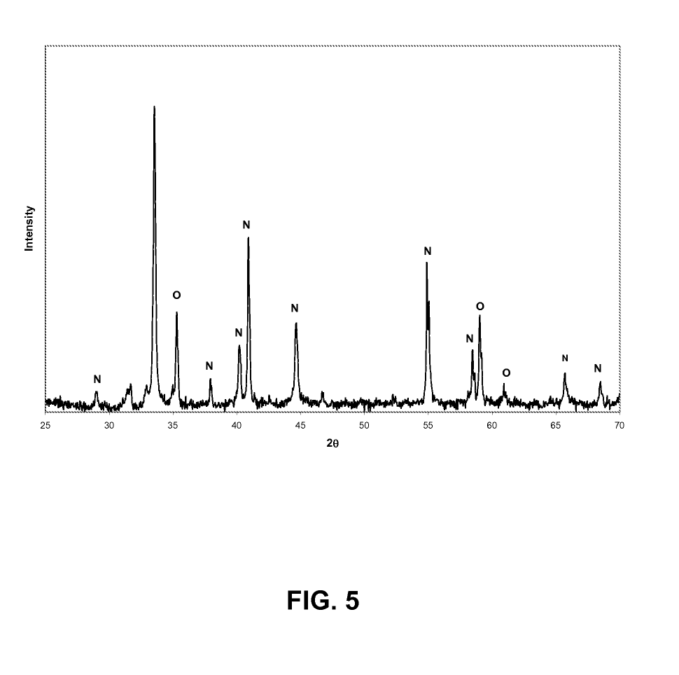

As mentioned above, addition of a nitrogen containing additive to the fuel-salt reactant mixture can improve nitride conversion of the product. This is illustrated in FIG. 5 where manganese nitrate, urea and sodium azide (NaN₃) were combined as defined in the chemical equation below:

$$3 {Mn ( {NO}_{3} )}_{2} + 27 {CO ( {NH}_{2} )}_{2} + 3 {NaN}_{3} + 30 {O}_{2} ( g ) \to {Mn}_{3} {N}_{2} + 54 {H}_{2} O ( g ) + 27 {CO}_{2} ( g ) + 33.5 {N}_{2} ( g ) + 3 NaO ( g )$$

The reaction was conducted under flowing ammonia gas and heated until 600° C. employing a heating rate of 100° C.·min⁻¹. Significant amounts of white off-gas started at 270 C and continued until 420 C for approximately 2 minutes. Ignition of the mixture occurred at 380 C with emission of a yellow/orange colored flame and an increase in the amount of off-gas. The resultant product was allowed to cool convectively under a flowing ammonia gas environment. Comparison of the urea fuel composition in FIG. 4 and FIG. 5 shows that the sodium azide additive does in fact increase the amount of nitride conversion.

Urea has been used with varying fuel to reactant ratios varying from 3:1 to 36:1. Lower fuel ratios (3:1 to 9:1) show more oxide production as well as particle sizes varying from 0.51 to 0.61 micrometers. As the ratio is increased, the ignition temperature and therefore the time to ignition also increase from approximately 320 C to 450 C and from 4-6 minutes once heating is started. In addition, nitride conversion is also increased. Particle size increases (0.59 to 0.65) with increasing fuel to reactant ratio (18:1), then the particle size decreases (0.46 to 0.54) as the ratio further increases (27:1 to 36:1). These results are summarized in Table 2.

| Fuel:Salt | Particle Size | Ignition T (° C.) | Wt % N₂ |
|---|---|---|---|
| 3:1 | 0.51-0.52 | 330 | 1.1 |
| 5:1 | 0.51-0.53 | 340 | 8.3 |
| 9:1 | 0.52-0.54 | 370 | 12.6 |
| 18:1 | 0.58-0.61 | 400 | 17.0 |
| 27:1 | 0.46-0.50 | 415 | 17.4 |
| 36:1 | 0.52-0.54 | 450 | 13.5 |

When a group of substituents is disclosed herein, it is understood that all individual members of those groups and all subgroups, including any isomers and enantiomers of the group members, and classes of compounds that can be formed using the substituents are disclosed separately. When a compound or method is claimed, it should be understood that compounds or methods known in the art including the compounds or methods disclosed with an enabling disclosure in the references disclosed herein are not intended to be included. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that method steps and starting materials other than those specifically exemplified can be employed in the practice of the invention without resort to undue experimentation. All art-known functional equivalents, of any such method steps and starting materials are intended to be included in this invention. Whenever a range is given in the specification, for example, a temperature range, a time range, a particle size range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention.

In general the terms and phrases used herein have their art-recognized meaning, which can be found by reference to standard texts, journal references and contexts known to those skilled in the art. The definitions are provided to clarify their specific use in the context of the invention.

All patents and publications mentioned in the specification are indicative of the levels of skill of those skilled in the art to which the invention pertains.

One skilled in the art would readily appreciate that the present invention is well adapted to carry out the objects and obtain the ends and advantages mentioned, as well as those inherent therein. The compounds used, products formed and methods and accessory methods described herein as presently representative of preferred embodiments are exemplary and are not intended as limitations on the scope of the invention. Changes therein and other uses will occur to those skilled in the art, which are encompassed within the spirit of the invention, are defined by the scope of the claims.

Although the description herein contains many specificities, these should not be construed as limiting the scope of the invention, but as merely providing illustrations of some of the embodiments of the invention. Thus, additional embodiments are within the scope of the invention and within the following claims. All references cited herein are hereby incorporated by reference to the extent that there is no inconsistency with the disclosure herein. Some references provided herein are incorporated by reference herein to provide details concerning additional starting materials, additional methods of synthesis, additional methods of analysis and additional uses of the invention.

We claim:

1. A method of preparing a high purity metal nitride and/or oxide powder, comprising:
(a) heating a metal salt and an organic fuel to an ignition temperature in a nitrogen-rich atmosphere, forming a composition;
(b) optionally quenching the composition; and
(c) optionally heating the composition to a heat treatment temperature, until the high purity metal nitride and/or oxide powder is formed.

2. The method of claim 1, further comprising adding a nitrogen source to the metal salt and organic fuel.

3. The method of claim 1, wherein the metal salt is metal nitrate, chloride, acetate or a mixture thereof.

4. The method of claim 1, wherein the metal is selected from the group consisting of: aluminum, americium, calcium, cerium, chromium, dysprosium, hafnium, iron, lanthanum, magnesium, manganese, neptunium, plutonium, praseodymium, uranium, zirconium and mixtures thereof.

5. The method of claim 1, wherein the organic fuel is selected from the group consisting of urea (CO(NH₂)₂), glycine (C₂H₅NO₂), N-methylurea (CH₃NHCONH₂), citric acid (HOC(COOH)(CH₂COOH)₂), stearic acid (CH₃(CH₂)₁₆COOH), ammonium bicarbonate (NH₄HCO₃), nitromethane, hexamethylenetetramine, ammonium carbonate ((NH₄)₂CO₃) and combinations thereof.

6. The method of claim 1, wherein the heat treatment heating is performed in a nitrogen-rich atmosphere which comprises above about 80% nitrogen.

7. The method of claim 6, wherein the nitrogen-rich atmosphere is nitrogen gas, ammonia gas, or a mixture thereof.

8. The method of claim 1, wherein the particle size of the powder is between 1 nm and 800 microns.

9. The method of claim 1, wherein the particle size of the powder is between 1 nm and 500 nm.

10. The method of claim 1, wherein the metal oxide is a mixed oxide.

11. The method of claim 1, wherein the heat treatment temperature is 1000° C. or below.

12. The method of claim 1, wherein the heat treatment temperature is below 750° C.

13. The method of claim 1, wherein the heat treatment temperature is maintained for a time less than one hour.

14. The method of claim 1, wherein the powder contains at least 99.9% metal nitride.

15. A method of preparing a high purity manganese nitride and/or oxide powder, comprising:
(a) heating a manganese salt and an organic fuel to an ignition temperature in a nitrogen-rich atmosphere, forming a first composition;
(b) optionally heating the first composition to a heat treatment temperature, which heat treatment temperature is above the ignition temperature and below 1000° C., in a nitrogen-rich atmosphere until the high purity manganese nitride and/or oxide powder is formed.

16. The method of claim 15, wherein the heat treatment step is performed for a time less than one hour.

17. A method of preparing a high purity americium nitride and/or oxide powder, comprising:
(a) heating an americium salt and an organic fuel to an ignition temperature in a nitrogen-rich atmosphere, forming a first composition;
(b) optionally heating the first composition to a heat treatment temperature, which heat treatment temperature is above the ignition temperature and below 750° C., in a nitrogen-rich atmosphere until the high purity americium nitride and/or oxide powder is formed.

18. The method of claim 17, wherein the heat treatment step is performed for a time less than one hour.

19. A high purity metal nitride or oxide powder made by the method of claim 1.
